(19) United States
(12) Patent Application Publication
(10) Pub. No.: US 2005/0211025 A1
(43) Pub. Date: Sep. 29, 2005

(54) Insulation stripping machine and method for stripping insulation from cables

(76) Inventors: Roger Steuri, Spiezwiler (CH); Reto Appenzeller, Uetendorf (CH)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/515,852

(22) PCT Filed: May 15, 2003
(86) PCT No.: PCT/IB03/01887

§ 371 Date: Jan. 6, 2005

(30) Foreign Application Priority Data
May 27, 2002 (CH) 2002 1011/02
May 31, 2002 (CH) 2002 0922/02

(51) Int. Cl. H02G 1/12

(52) U.S. Cl. 81/9.51

(57) ABSTRACT

The invention relates to an insulation stripping machine, particularly a bench machine, comprising non-rotating blades, a programmable computer control and at least one blade (14) for the controlled cutting into and cutting through a cable (50) as well as for stripping the insulation therefrom.

### BACKGROUND

The invention relates to an insulation stripping machine and a novel control for novel methods for semiautomatic stripping of insulation from cables The machine executes programmable sequences of relative stripping movements between a cable and at least one knife. Machines of this general type, an example of which is the Schleuniger MP 257, have been known as insulation stripping machines for coaxial cables. However, machines such as the Schleuniger CS 9100, or fully automatic and cut and strip machines, may be viewed as expressly excepted. The Schleuniger CS 9100 permits continuous processing of a cable. The invention primarily concerned with so-called table machines which can be placed on a table and in principle are not installed in automatic processing lines but into which cable ends are introduced and removed again manually or by a robot arm or the like. The reason for this distinction is that the excluded automatic or continuously processing insulation stripping machines mentioned and the table machines produced in parallel have been increasingly subject to a technological separation in recent years and now represent completely different machine types, both from the point of view of use and from the point of view of design. The technologies have accordingly separated and are therefore also considered independently of one another by a person skilled in the art.

The inventors recognized that the known systems are disadvantageous with respect to the following points:

The rotating knives used can only close to zero (i.e. the cable axis) since the cutting edges are opposite one another and hence problems might be encountered when completely cutting through cables. It should be taken into account that to date the machines with a rotational action have not had to meet any requirements in this regard since the cables introduced had already been cut through by other machines and since the cable end (the end face) was always taken as a reference.

It is however disadvantageous to take the existing cable end face as a reference since this may be uneven in certain circumstances and the insulation stripping in the axial direction then could not be exactly reproducible.

The actuation of rotating knives and the mounting and maintenance thereof are complicated and require certain construction volumes.

Rotating knives can also impose a torsional load, particularly on thin cables, which may be undesirable.

The person skilled in the art was of course also familiar with pneumatically driven insulation stripping machines having nonrotating knives, such as, for example, the Schleuniger 2015 (which is technologically substantially older than the MP 257 from Schleuniger which was mentioned) or the Schleuniger 2100, but these machines were equipped only for relatively simple insulation stripping processes and were therefore not used particularly where particularly high accuracy was required. They therefore did not prompt the person skilled in the art to take a lead from this direction for improving the rotational machines which had a refined computer control both for radial and for axial determination of insulation stripping dimensions.

### SUMMARY

It is therefore the object of the invention to provide an apparatus which avoids these and other disadvantages and to construct a machine which permits insulation to be stripped from cables and cables to be cut through with higher precision but with less effort.

This object is achieved—starting from semiautomatic rotational table insulation stripping devices—by a surprising step into the past, which is not obvious, namely
use of nonrotating knives, comparable with the knives from the Unistrip 2500, it being possible for the knives to slide past one another and for a cable to be safely cut through completely, and the use of a programmable electronic control, as known, for example, from the MP 257.

Further developments of the invention and especially novel methods for using the electronic control for novel insulation stripping processes and variants thereof are further described in the detailed disclosure.

There it will be understood that the invention provides an insulation stripping machine comprising a programmable electronic control and including a stripping carriage for relative stripping movement with respect to a cable axis and between a cable and at least one knife that may be actuated by at least one knife actuating element. Electrical or pneumatic drives may drive the stripping carriage and knife actuating elements. A measuring sensor or at least one knife sensor may directly or indirectly determine the position of the stripping carriage, the knife, the cable, or any combination of the three elements. The control program may effect varying series of novel insulation stripping operations via control of the machine's components. The various novel insulation stripping methods may be used advantageously and in an inventive manner, some even independently of the use on a table machine according to the invention, for example in cut-and-strip machines or in fully automatic machines.

The invention may include non-rotating knife and knife actuating element that are formed for completely cutting through a cable or for cutting over more than the total thickness of the cable. Furthermore, the invention may include at least one cable sensor for measuring at least one cable-specific cable parameter such as cable diameter. This cable sensor may feed measured cable parameters to the programmable control in order to assist program control of the insulation stripping process. The program control, in turn, may include a cable database including cable curves that represent the average cable parameters when cutting through the respective cables.

By means of the invention's novel combination of numerous improvements, including the following, are achieved:

a compact machine is provided;

it operates with high precision and, particularly with regard to the insulation stripping length, permits improved accuracy since cutting through of the cable and measurement of the insulation stripping length from the point cut through as a reference point become possible for the first time without problems in table machines;

in addition, the insulation stripping process is even faster owing to the lack of the rotational movement;

the machine can also be used universally and for a very wide range of cables and it permits software-supported expandability with regard to a very wide range of advantageous further developments in insulation stripping methods known per se.

In the above text, reference is made to a knife lever; however, the invention is not limited thereto, but rather other force transmission means are also available between drives and knives. Thus, the knives could also be driven—electrically or pneumatically—by linear drives, provided that the mechanism used permits dimensionally accurate and computer-controlled feeding of the knives.

In the context of the invention, suitable knives are various known knives and also future novel knives, the invention including both versions with only one knife or with two knives (typical design) or with a plurality of knives, but typically not rotating.

The invention comprises, as known per se, at least one knife sensor which serves for position determination of the cable, of the knife or of other movable parts of the insulation stripping machine. In the context of the invention, a knife sensor is to be understood as meaning an individual sensor or an apparatus comprising a plurality of sensors and/or cooperating components which together have a sensor function, for example including stepping motors or the like. The patent claims should accordingly be broadly interpreted. The person skilled in the art is expressly referred to the sensors in insulation stripping technology which are known per se, as disclosed in the machines mentioned and in the literature. There is therefore no need to go into detail in this context here.

In particular, the invention provides, in a further development, sensors which determine the dimensions of an introduced cable and derive therefrom instructions for processing the cable. Such sensors could cooperate, for example, with the knives or knife supports in that they are used there as contact or pressure or force sensors and the thickness of the cable is detected by closing of the knives or clamping jaws to the outer sheath of the cable. Especially when processing a set of different cables in succession, this novel measurement or subsequent control can have advantages for the user since—assuming prior programming—he can introduce the various cables on the basis of discretion and is not tied to a specific sequence of introduction, as was already known per se (wirelisting).

According to the invention, it is therefore possible to provide in the programmable control a memory in which is stored a cable list which contains information about the cable corresponding to the diameter and can use this information directly for actuating the insulation stripping machine.

On the other hand, the machine according to the invention can also be programmed with wirelisting.

The invention thus also provides for the first time a table machine with a “wirelisting facility”, so that cables of cable trees or the like can be stripped of insulation in sequence.

Suitable drives are various motors known per se. Preferably, a separate dc motor with encoder can be provided for each drive, the encoder also performing the sensor function known per se in order to register the position of the driven component.

According to a particular development of the invention, centring is provided for increasing the accuracy of insulation stripping and for avoiding damage to the inner conductor of the cable, which centring is preferably provided by spring-mounted centring jaws supported relative to the knives. If required, such centring jaws also permit a cable stripping method which is novel for stand-alone devices, which method makes it possible to straighten, for example, curved or wavy cables before the actual insulation stripping process. For a detailed stripping process, reference is made to EP-B-1070374 of the Applicant, which in this context and in particular with its figures and associated description of figures is considered to have been disclosed herein.

The list of reference numerals and the figures, together with the objects described or protected in the Claims, are an integral part of the disclosure of this Application. These and other features, aspects, and advantages of the present invention will become better understood with regard to the following description, appended claims, and accompanying drawings, where:

### BRIEF DESCRIPTION OF THE DRAWINGS

The figures are described in relation to one another and as a whole. Identical reference numerals denote identical components, and reference numerals with different indices indicate functionally identical components.

FIG. 1 schematically shows the overall design of an insulation stripping machine according to the invention;

FIG. 2 schematically shows the overall design of an insulation stripping machine according to the invention, in a exploded view;

FIGS. 3a-3d schematically] show the design of a spring-mounted cable centring means, FIG. 3a showing the front view, FIG. 3b a side view, FIG. 3c the sectional view along the sectional axis A-A and FIG. 3d an oblique view;

FIG. 4 shows the spring-mounted cable centring means in an exploded view;

FIGS. 5a-5e show the views of a radial knife according to the invention;

FIGS. 6a and 6b show the various angles made by the knife and the knife lever;

FIGS. 7a-7c show the various views of the baseplate;

FIG. 8 shows a stripping carriage according to the invention, in an exploded view, and

FIGS. 9a-9h show novel insulation stripping processes according to the invention.

### DETAILED DESCRIPTION

For a deeper more detailed understanding of the figures, the person skilled in the art is, if required, expressly referred to the list of reference numerals.

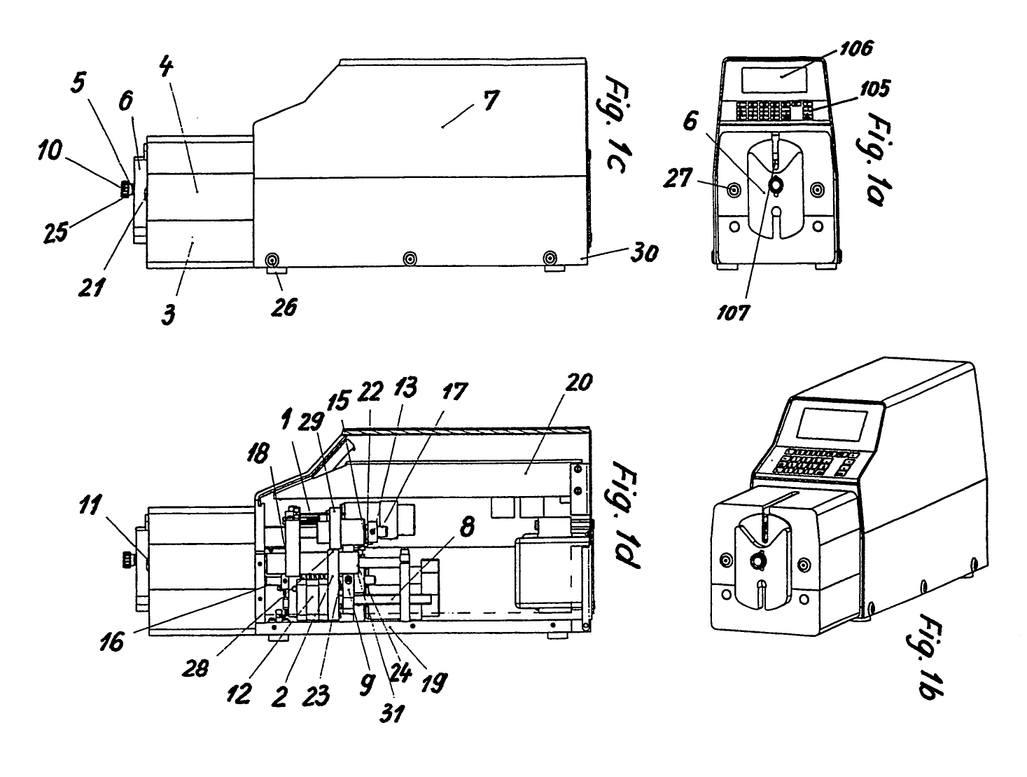

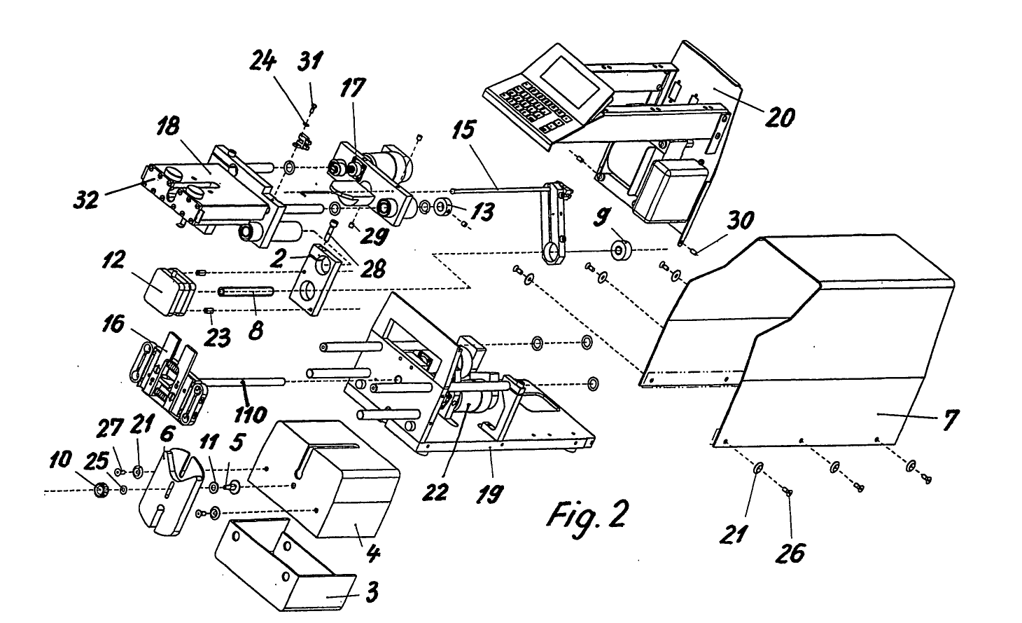

FIG. 1a-d show various views of an insulation stripping machine according to the invention, in the assembled state. Here, FIG. 1a shows the front view with a display 106 and a keypad 105 and a cable opening 107 into which the cable to be processed can be introduced. Behind the display 106 and up to the rear plate of the frame 20 (FIG. 2), the control (microprocessor or computer) is housed in a manner not shown in detail but known per se to a person skilled in the art.

FIG. 1b shows an oblique view of the machine.

FIG. 1c shows that a spacer plate 6 can be adjusted by means of a knurled nut 10 and that the machine is provided with a waste container 3 for receiving the stripped-off insulation pieces 104. The machine is protected by means of the protective covers 4 and 7.

The section through the housing cover 7 in FIG. 1d provides a view onto a drive 22, which moves a stripping carriage 18. A servo motor 12 is responsible for driving said carriage and for adjusting a trigger 15 which is responsible for the insulation stripping length.

All drives, stepping motors and servo motors and the trigger 15 are computer-controlled.

FIG. 2 shows, in an exploded view, the inner workings of an insulation stripping machine according to the invention. Here, it is clear that a stepping motor 12 controls the operating path of a stripping carriage 18 by means of a trigger 15 in such a way that the desired insulation stripping length is reached. Stepping motors 22 on a baseplate 19 are responsible for controlling a cable clamp 16.

The fundamental method of controlling the stripping carriage 18 and the tools by means of spindles, shaft encoders, etc. is known in principle to a person skilled in the art and therefore need not be explained in more detail, this also being true of the actuation by means of a computer.

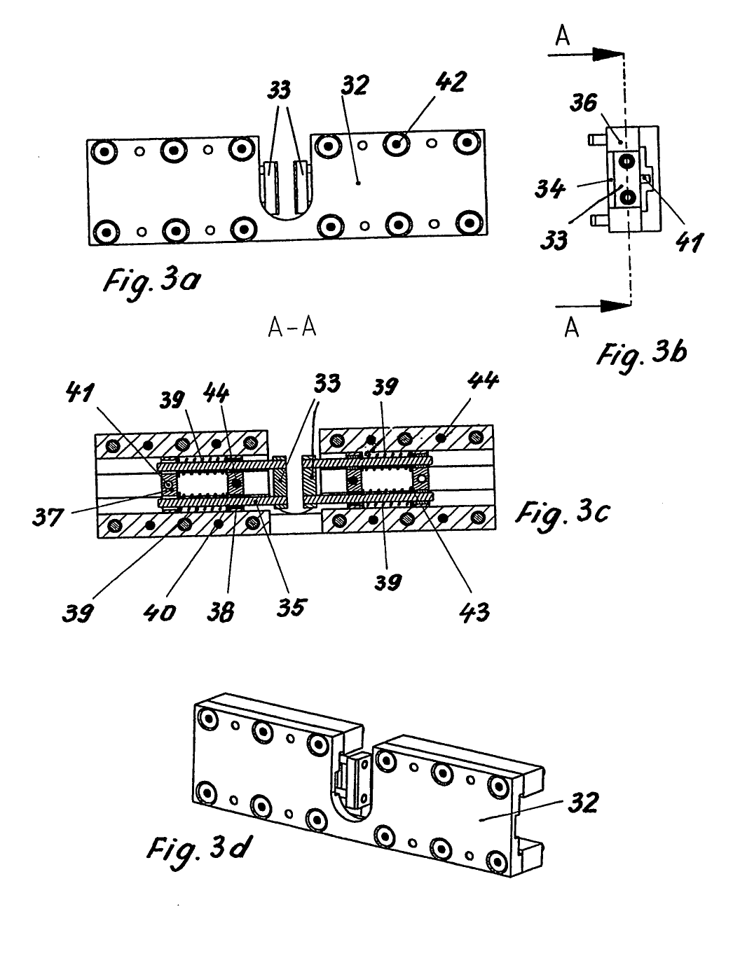

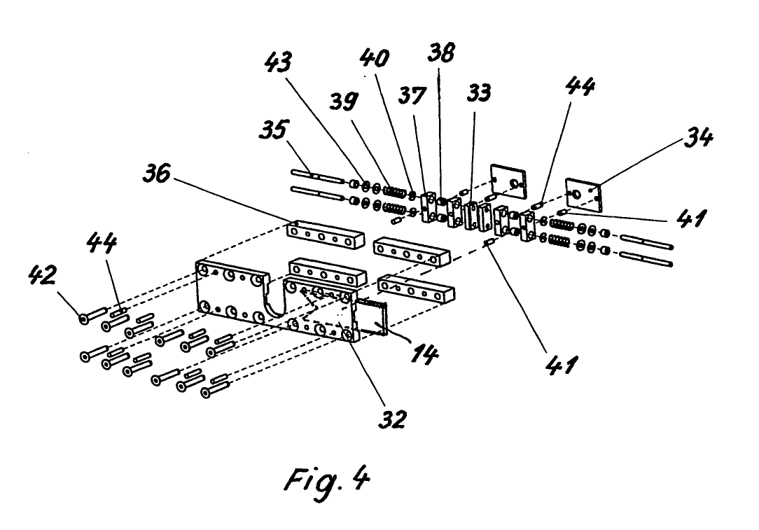

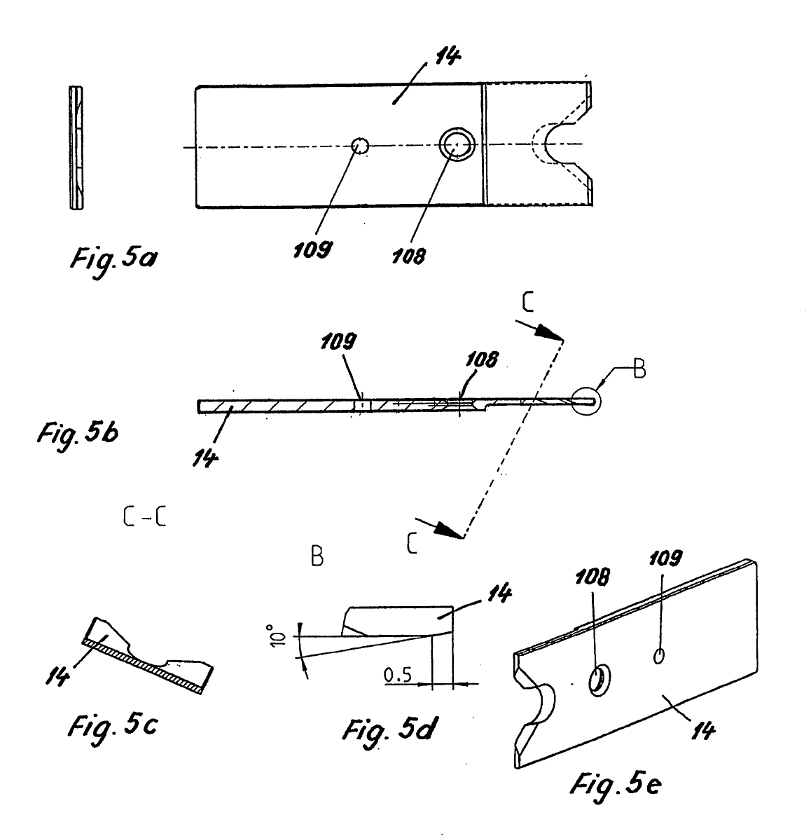

FIGS. 3a-d show the various views of a spring-supported cable centring means, which rests on the end face of the stripping carriage 18.

FIG. 3a shows the front view of a front plate 32. The thrust plates 33 which are opposite one another and which centre a cable which has been introduced are arranged in a U-shaped trough through which the cable runs.

FIG. 3b, a side view of FIG. 3a, shows that the thrust plates run inside a guide which is formed from a guide holder 36 and the guide plate 34.

The sectional view along the sectional axis A-A from FIG. 3c shows the design of the two thrust plates 33 which are opposite one another and the arrangement of four centring springs 39. The actuation of the cable centring means is effected via a connecting pin 41 and a guide plate 34 between the insulation stripping knives 14 (FIG. 4).

FIG. 3d shows an oblique view of the cable centring means.

FIG. 4 shows the spring-supported cable centring means in an exploded view. Here, the mounting position of a knife 14 is shown schematically. The opposite knife is not shown. Furthermore, the individual design of the spring-operated thrust plate 33 is shown.

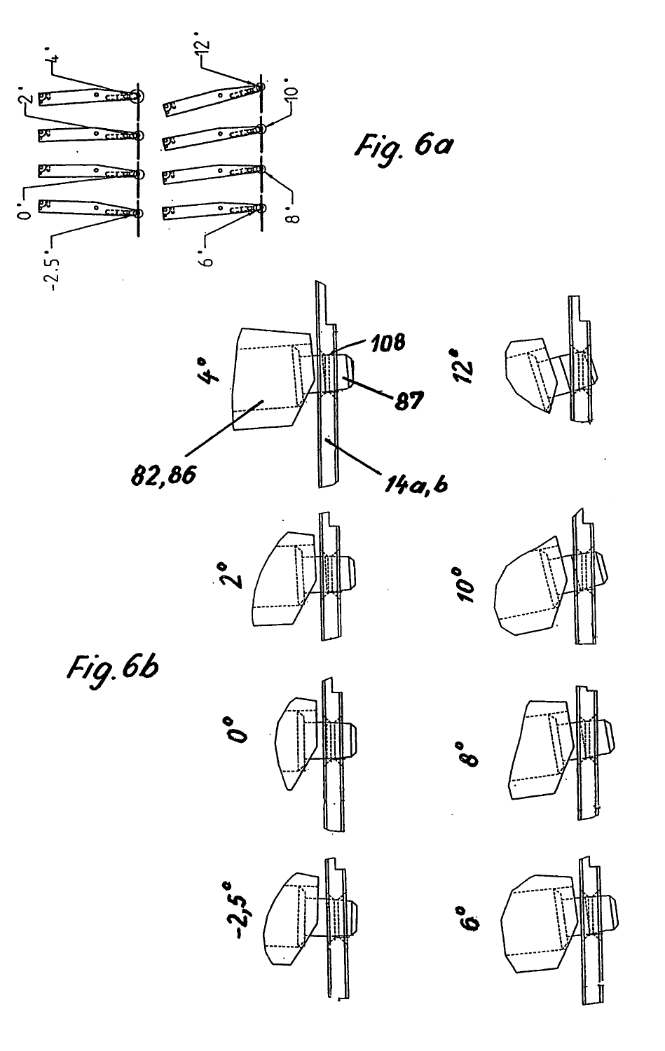

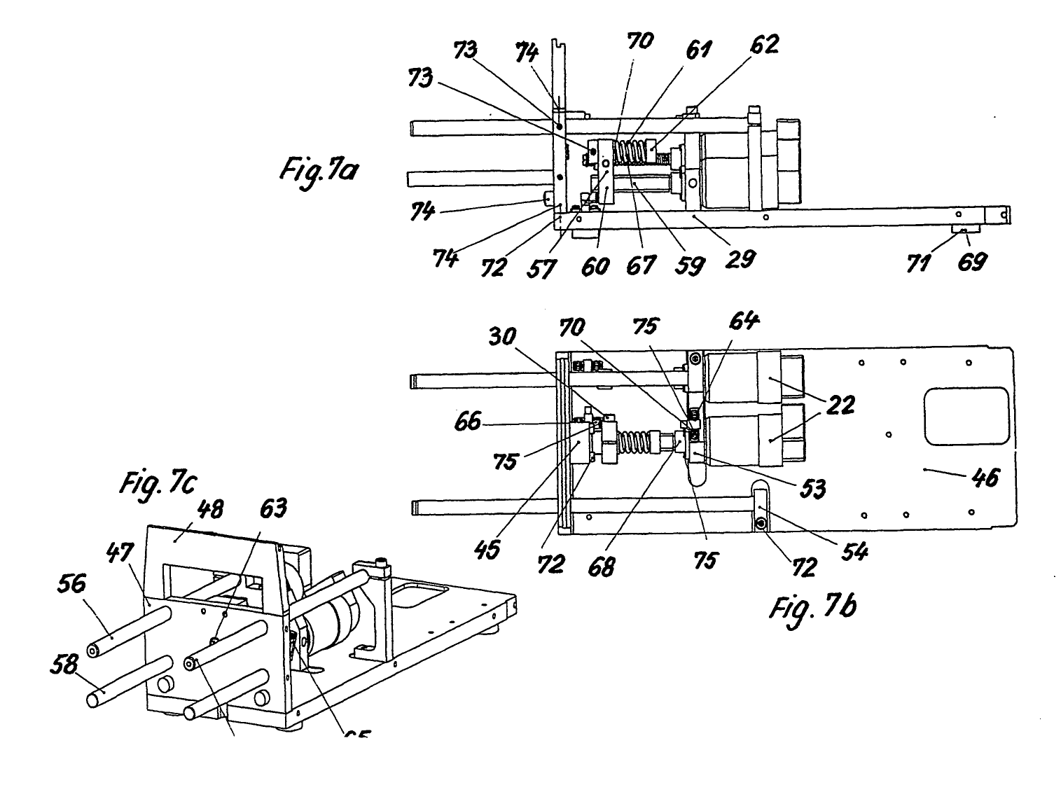

FIG. 5a-e show the various views of a radial knife 14 according to the invention, having a recess 108, where the knife levers 82 and 86 (not shown) engage (FIG. 6) and a guide hole 109 where the connecting pin 41 for controlling the cable centring means engages.

FIG. 6a and 6b show the various preferred angles which the left knife lever 82 or the right knife lever 86 and the knife 14 can make without play occurring between the knife lever and knife 14 in the recess 108.

The angle and length data in FIG. 5 and 6 are preferred approximate dimensions. However, the invention is not restricted to the knives 14 shown.

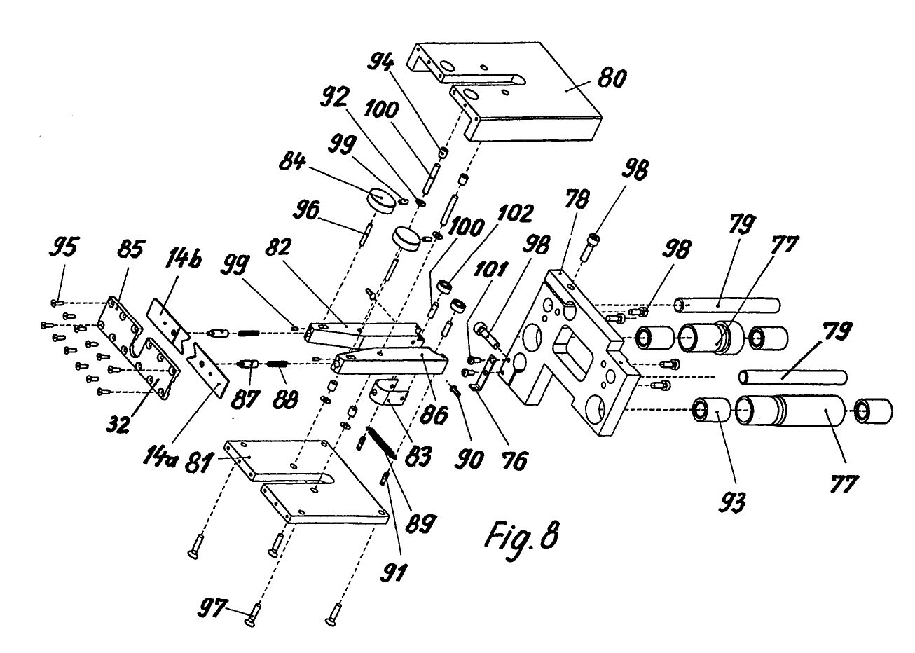

FIG. 7a shows a side view of the baseplate 19 which serves as an assembly for the cable clamping means, FIG. 7b shows a plan view, which also shows the two drives 22, and FIG. 7c shows a perspective view. A drive rod 110 (FIG. 2) for operating the cable clamping means 16 passes through a bush 63 and is controlled by means of a trapezoidal spindle 59. The hardness of closing of the cable clamping means 16 is adjusted by means of an adjusting plate 57, a pressure spring 61 and nut 60 and adjusting spring 62 enclosing it.

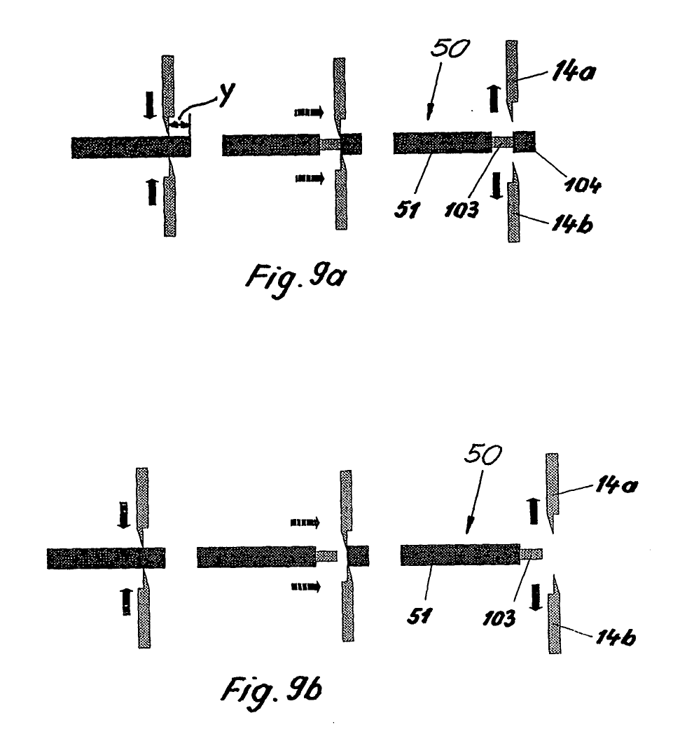

FIG. 8 shows the stripping carriage in an exploded view. Here, it is evident that the knife levers 82 and 86 move the knives 14a and 14b by means of the locking pins 87.

The knives 14a and 14b are forced apart with a cone (not shown) by means of the knife levers 82 and 86.

Thus, according to FIGS. 1-8, preferred versions of the stripping machine may comprise a programmable electronic control and a control program for making an incision in and stripping off (insulation) layers (51) and for cutting through a cable (50), comprising a stripping carriage (18) for a relative stripping movement with respect to the cable axis and between cable (50) and at least one knife (14), and comprising at least one knife actuating element (82, 86) having electrical or pneumatic drives (22) for the stripping carriage (18) and the knife actuating element (82, 86), and comprising at least one knife sensor (49) for at least indirect position determination of the stripping carriage (18) and/or of the knife (14) and/or of the cable (50), characterized in that the control program comprises programmable control steps (which can be optionally switched on and off) by means of which the drives (22) for the stripping carriage (18) and the knife actuating element (82, 86) can be driven so that they permit novel insulation stripping operations. Further, according to FIGS. 1-8, preferred versions of the stripping machine may comprise a programmable electronic control and a control program for controlled and dimensionally accurate incision and stripping of (insulation) layers (51) on a cable (50), comprising a stripping carriage (18) for a relative stripping movement axially with respect to the cable, likewise controlled by the control program and between cable (50) and at least one knife (14), and comprising at least one knife actuating element (82, 86), having electrical or pneumatic drives (12, 22) for the stripping carriage (18) and the knife actuating element (82, 86), and comprising at least one measuring sensor (49) for at least indirect position determination of the stripping carriage (18) and/or of the knife (14) and/or of the cable (50), the control program comprising programmable control steps (which can optionally be switched on and off), by means of which the drives (12, 22) of the stripping carriage (18) and the knife actuating element (82, 86) can be actuated, characterized in that the knife (14) and its knife actuating element (82, 86) are non-rotating and that the knife (14) or its knife actuating element (82, 86) are formed for completely cutting through a cable (50) or for cutting over more than the total thickness of the cable (50).

It is also stated that, according to FIGS. 1-8, preferred versions of the stripping machine may comprise a programmable electronic control and a control program for making an incision in and stripping off (insulation) layers (51) and for cutting through a cable (50), comprising a stripping carriage (18) for a relative stripping movement with respect to the cable axis and between cable (50) and at least one knife (14), and comprising at least one knife actuating element (82, 86) having electrical or pneumatic drives (22) for the stripping carriage (18) and the knife actuating element (82, 86), and comprising at least one knife sensor (49) for at least indirect position determination of the stripping carriage (18) and/or of the knife (14) and/or of the cable (50), characterized in that the clamping jaws (16) are formed in such a way that, when stripping the insulation from multi-conductor cables, they can be moved in such a way that the shoulder of the initially stripped layer is used by them as a stop for orienting the knives (14) again.

Furthermore, as is also illustrated in the accompanying FIGS. 1-8, preferred versions of the stripping machine may include two knives (14) which are held on opposite knife holders (82, 86) in such a way that they can move past one another and their blade edges—preferably both blade edges—can each be advanced beyond the cable axis. The two knives (14) may travel towards one another, as depicted. Furthermore, the knife (14) may have a concave shape—preferably U-shape or V-shape—on its cutting edge.

Preferred versions of the machine may include at least one cable sensor for measuring at least one cable-specific cable parameter, in particular a cable diameter, the cable sensor being connected to the control and, in the operating state, the measured cable parameters being fed into the control at least from case to case for program control of the insulation stripping process. The cable sensor may comprise at least one cable diameter sensor for measuring at least one external and/or internal diameter, and/or a pressure sensor and/or a cutting force sensor, and/or that the cable sensor comprises a measuring apparatus on a bed motor for the knife (14) and/or clamping jaw. Furthermore, the control program may comprise a cable database from which, in the operating state, a selection of cables or one cable can be proposed to the user, in particular can be shown on a display (106), automatically and as a function of the measured cable parameters. The cable database may contain cable curves which represent the average cable parameter when cutting through the respective cables.

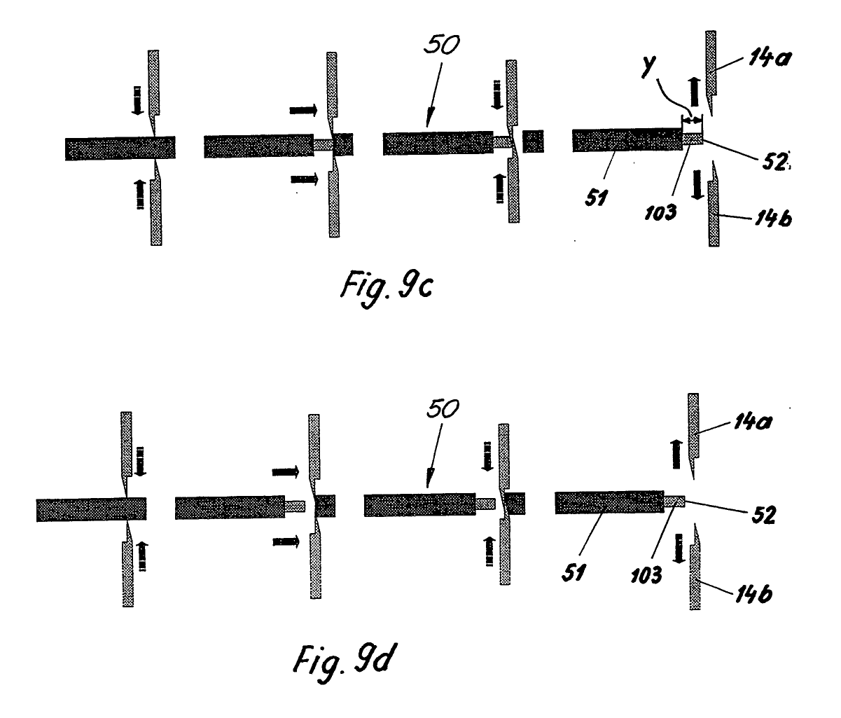

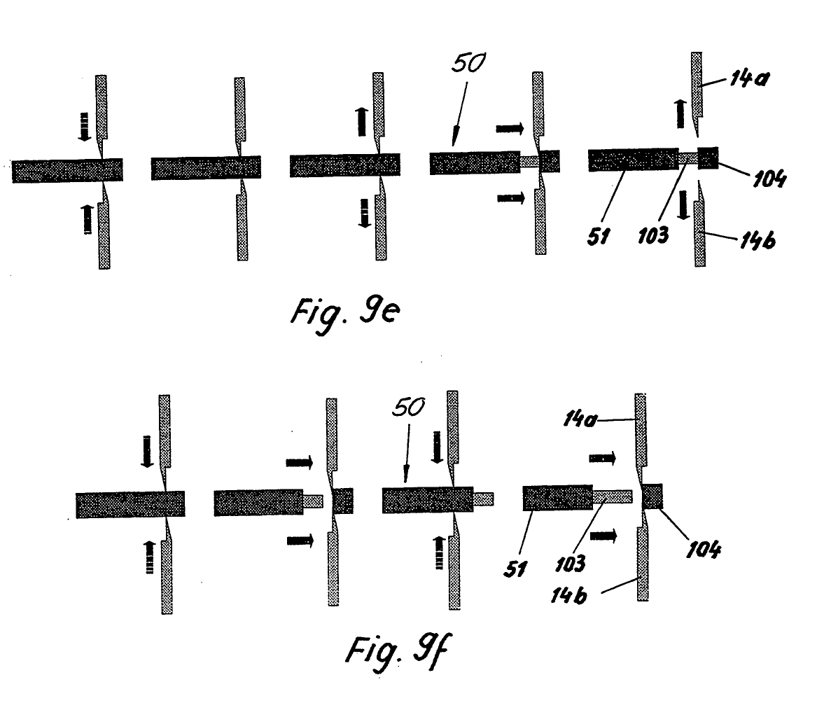

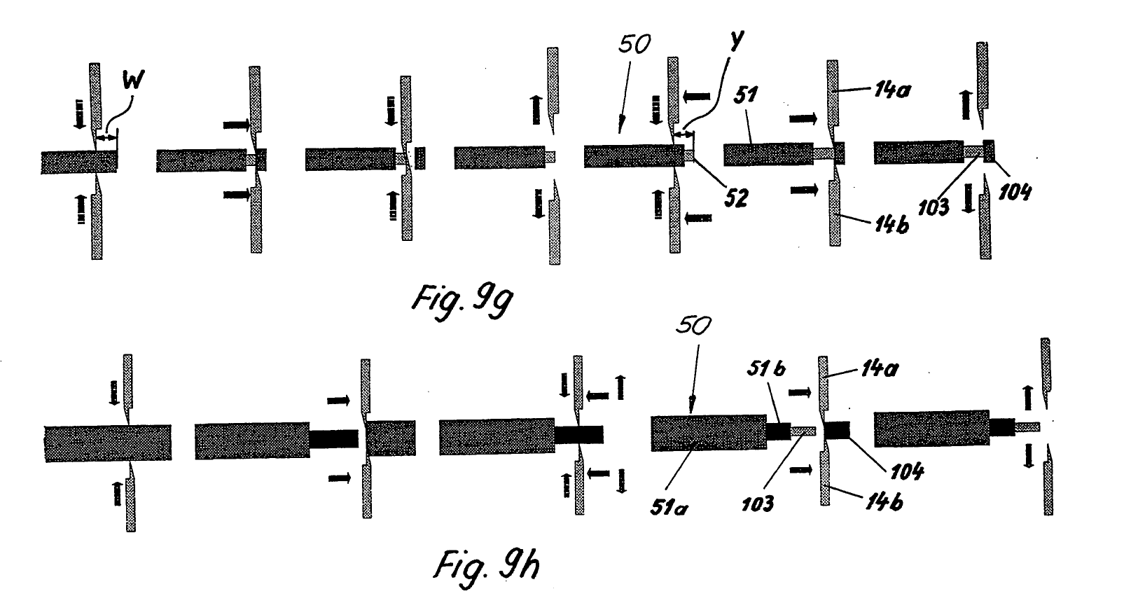

FIG. 9a shows the sequence of movement of the knives 14a and 14b during partial stripping of the insulation 51, so that the insulation piece 104 stripped of still remains for protecting the cable end 52 and only a part of the stripped wire 103 is visible. Preferably, the knives move back slightly again (horizontal arrows in right part of the figure) before they open (vertical arrows) in order to rule out friction against the stripped-off insulation piece 104.

FIG. 9b shows the complete stripping of the insulation, known per se.

FIG. 9c shows complete stripping with subsequent cutting, according to the invention, of the cable end 52, which leads to more exact insulation stripping lengths Y.

FIG. 9d shows complete stripping of the insulation with subsequent further cutting of the insulation, so that the stripped-of insulation piece 104 does not adhere to the knives 14 or remaining hanging on the parts of the remaining insulation.

FIG. 9e shows the sequence of partial striping with “wayback”. Here, the knives 14a and 14b are retracted slightly again after the cutting, so that they do not damage the wire 103 when stripping off the insulation 104. This process is known per se in the case of rotational insulation stripping processes on table machines and is now possible for the first time also in the case of stationary knives.

FIG. 9f shows stepwise multiple stripping with complete stripping (also possible for partial stripping), which may be necessary if, owing to its characteristics, the insulation is particularly difficult to detach from the wire 103.

FIG. 9g shows partial stripping with prior cutting. Here, complete stripping is first performed, cutting is then effected and partial stripping is then performed, which leaves the stripped piece on for protecting the cable end. This novel method leads to particularly exact and well protected wire ends.

FIG. 9h shows multistage insulation stripping of coaxial cables, as is possible by the computer control according to the invention, also for such table units (and without rotating knives—as known per se).

Thus, with reference to FIGS. 9a-9h, it will be understood that preferred versions of the invention may be operated so that they permit at least one of the following insulation stripping operations:

a) in combination:

i) the knife (14) cuts into a layer (51) to be stripped at a distance (X) from the cable end (52) which is greater than the desired insulation stripping length (Y)

ii) the stripping carriage (18) performs a stripping movement which corresponds to the desired insulation stripping length (Y) or a desired cable end position

iii) the knife (14) cuts through the cable completely (subsequent cutting known per se) and

iv) the stripping carriage (18) performs a further stripping movement before the knife (14) or the knife actuation element (8, 12) opens

and/or

(novel for rotating and nonrotating knives):

b) in combination:

i) the knife (14) cuts into a layer (51) to be stripped at a distance from the cable end (52) which corresponds to the desired insulation stripping length (Y);

ii) the insulation stripping carriage (18) performs a stripping movement which is shorter than the desired insulation stripping length (partial stripping known per se);

iii) the stripping carriage (18) performs an opposite stripping movement before the knife (14) or the knife actuating element (8, 12) opens (wayback in axial direction);

and/or

(dwell time)

c) in combination:

i) the knife (14) cuts into a layer (51) to be stripped at a distance from the cable end (52)

ii) the knife (14) remains in the incision position for an adjustable time in order to ensure complete incision into this layer (51) before the knife (14) or the knife lever (82, 86) opens again or one of the steps a)i) or b)ii) to b)iii) is performed;

and/or

d) in combination:

i) the knife (14) cuts into a layer (51) to be stripped at a distance from the cable end (52);

ii) the insulation stripping carriage (18) performs a stripping movement which is longer than the desired insulation stripping length (complete stripping known per se);

iii) the knife (14) cuts completely through the layer (51) to be stripped before it opens again in order thus to prevent adhesion of stripped-off insulation pieces to the knife or to cut through a remaining residual connection between insulation layer and stripped-off insulation piece;

and/or

e) in combination:

i) the knife (14) cuts into a layer (51) to be stripped at a distance (W) from the cable end (52) which is shorter than the desired insulation stripping length;

ii) the stripping carriage (18) performs a stripping movement which is shorter than the distance (W);

iii) the knife (14) cuts through the cable completely (subsequent cutting known per se);

iv) the knife opens and travels from this position to the desired insulation stripping length (Y) and cuts there into the layer (51) to be stripped;

v) the insulation stripping carriage (18) performs a stripping movement which is shorter than the desired insulation stripping length (partial stripping known per se);

vi) the knife (14) opens or

vii) the stripping carriage (18) performs an opposite stripping movement before the knife (14) or the knife actuating element (8, 12) opens (wayback in axial direction);

and/or

f) in combination and limited to a table machine:

i) the knife (14) cuts into different layers of a coaxial cable with nonrotating cuts in different depths and optionally at different distances from the cable end and

ii) strips the respective separated sections of the layers together or stepwise from the cable;

and/or

g) in combination and limited to a table machine:

i) the knife (14) cuts into a layer (51) to be stripped at a distance (W) from the cable end (52);

ii) the stripping carriage (18) performs a stripping movement which is shorter than the distance (W) or corresponds to a desired cable end position;

iii) the knife (14) cuts through the cable completely (subsequent cutting) and

preferably: (partial stripping with subsequent cutting)

iv) the knife (14) or the knife actuating element (82, 86) opens;

v) the knife travels to a point on the cable (50) which is a distance from the cable end (52) which corresponds to the desired insulation stripping length (Y);

vi) the knife cuts the layer (51) to the desired depth and

vii) the stripping carriage (18) performs a stripping movement which is shorter than the desired insulation stripping length (Y) or corresponds to a desired cable end position.

The invention is not limited by the description of the figures, it serves merely for describing embodiments of the invention. On the other hand, the features described therein are available for supporting the Claims. The spirit and scope of the appended claims should not be limited to the description of the preferred versions contained herein.

### List of Reference Numerals

Knife holder
Sensor motor holder
Waste container
Protective hood
Adjusting screw
Spacer
Housing cover
Knife actuating element
Nut
Knurled nut
Washer
Drive, stepping motor, servo motor
Adjusting ring
Knife
Trigger
Cable clamping means
Cutting carriage
Stripping carriage
Baseplate
Frame
Washer
Drive, stepping motor, servo motor
Spacer
Washer
Washer
Countersunk screw
Countersunk screw
Socket-head cap screw
Setscrew
Setscrew with journal
Cheese-head screw with slot
Front cover
Thrust plate
Guide plate
Axle
Spacer
Side plate
Sliding bearing
Centring spring
Lock washer
Connecting pin
Straight pin
Washer
Straight pin
Cover of front plate
Baseplate
Front plate, bottom
Front plate, top
Knife sensor
Cable
(Insulation) layer
Cable end
Support, middle
Support, right
Stripping carriage guide, right
Stripping carriage guide, left
Adjusting plate
Retaining rod
Trapezoidal spindle for clamping movement
Nut
Pressure spring
Adjusting ring
Bush
Fork light barrier
Flange
Aperture
Spindle
Coupling
Elastic buffer
Washer
Countersunk screw
Socket-head cap screw
Setscrew
Straight pin
Cheese-head screw with slot
Switching vane
Guide sleeve
Retaining plate
Cutting carriage guide
Lever guide, top
Lever guide, bottom
Knife lever, left
Sealing component
Locking knob
Front cover
Knife lever, right
Locking pin
Locking spring
Spring for knife holder
Grooved stud
Grooved pin
Shim
Bearing
Sliding bearing
Countersunk screw
Straight pin
Countersunk screw
Socket-head cap screw
Setscrew
Straight pin
Cheese-head screw with slot
Grooved ball bearing
Wire
Stripped-off insulation piece
Keypad
Display
Cable opening
Recess
109 Guide hole
110 Drive rod
   W Distance
   X Distance
Y Insulation stripping length

1-10. (canceled)

11. A cable insulation stripping machine comprising:
a stripping carriage assembly capable of performing an axial stripping movement;
a first drive connected to said stripping carriage;
a nonrotating stripping knife assembly;
a second drive connected to said stripping knife
a measuring sensor assembly; and,
an electronic control operatively communicating with said sensor assembly and with said first and second drives, whereby said electronic control controls said stripping knife assembly to cut completely through a cable.

12. The cable insulation stripping machine of claim 11, wherein said measuring sensor assembly at least indirectly determines position of said stripping carriage assembly.

13. The cable insulation stripping machine of claim 11, wherein said measuring sensor assembly at least indirectly determines position of said knife assembly.

14. The cable insulation stripping machine of claim 11, wherein said measuring sensor assembly at least indirectly determines cable position.

15. The cable insulation stripping machine of claim 11, wherein said measuring sensor assembly at least indirectly determines position of said stripping carriage assembly and of said knife assembly.

16. The cable insulation stripping machine of claim 11, wherein said measuring sensor assembly at least indirectly determines cable position and position of said stripping carriage assembly.

17. The cable insulation stripping machine of claim 11, wherein said measuring sensor assembly at least indirectly determines cable position and position of said knife assembly.

18. The cable insulation stripping machine of claim 11, wherein said measuring sensor assembly at least indirectly determines cable position, position of said stripping carriage assembly, and position of said knife assembly.

19. The cable insulation stripping machine of claim 11, wherein said measuring sensor assembly includes at least one cable sensor measuring at least one cable-specific parameter, and,
said measuring sensor assembly linked in operative communication with said electronic control to communicate said at least one cable-specific parameter to said electronic control.

20. The cable insulation stripping machine of claim 19, wherein said at least one cable-specific parameter includes a cable diameter.

21. The cable insulation stripping machine of claim 20, wherein said cable diameter includes an external diameter.

22. The cable insulation stripping machine of claim 20, wherein said cable diameter includes an internal diameter.

23. The cable insulation stripping machine of claim 19, wherein said at least one cable sensor includes a pressure sensor.

24. The cable insulation stripping machine of claim 19, wherein said at least one cable sensor includes a cutting force sensor.

25. The cable insulation stripping machine of claim 19, wherein said at least one cable sensor includes a cable diameter sensor and a pressure sensor.

26. The cable insulation stripping machine of claim 19, wherein said at least one cable sensor includes a cable diameter sensor and a cutting force sensor.

27. The cable insulation stripping machine of claim 19, wherein said at least one cable sensor includes a pressure sensor and a cutting force sensor.

28. The cable insulation stripping machine of claim 19, wherein said at least one cable sensor includes a cable diameter sensor, a pressure sensor, and a cutting force sensor.

29. The cable insulation stripping machine of claim 19, wherein said at least one cable sensor includes a feed motor measuring apparatus.

30. The cable insulation stripping machine of claim 19 further including,
a display, and
a cable database, and
said display and said cable database operatively associated with said electronic control to cause said display to automatically display data derived from said cable database.

31. The cable insulation stripping machine of claim 30, wherein said electronic control operates to select data to be displayed from said cable database as a function of measurements communicated from said cable sensor assembly.

32. The cable insulation stripping machine of claim 30, wherein said cable database contains cable curves representative of average cable parameters.

33. The cable insulation stripping machine of claim 11, wherein said stripping knife assembly includes at least two knives capable of moving towards one another.

34. The cable insulation stripping machine of claim 11, wherein said stripping knife assembly includes,
knife holders,
at least two knives, and
said knives having blades that overlap at closure.

35. A cable insulation stripping machine comprising:
at least one stripping knife,
a knife actuating element operatively connected to said at least one stripping knife,
a first drive for said knife actuating element,
a stripping carriage for effecting a relative stripping movement between said at least one stripping knife and a cable,
a second drive for said stripping carriage,
at least one knife sensor,
a programmable electronic control operatively communicating with said at least one knife sensor and with said drives, and
at least one set of clamping jaws registering a shoulder of an initially stripped cable insulation layer as a stop for orienting said at least one stripping knife.

36. An insulation stripping machine comprising:
at least one stripping knife,
a knife actuating element operatively connected to said at least one stripping knife,
a first drive for said knife actuating element,
a stripping carriage for effecting a relative stripping movement between said at least one stripping knife and a cable,
a second drive for said stripping carriage,
at least one knife sensor,
a programmable electronic control operatively connected to said sensor and to said drives, said programmable electronic control containing program instructions that, when executed cause said stripping knife and said stripping carriage to perform a method of stripping an insulated cable, the method comprising:
cutting into a cable insulation layer at a first distance from a cable end that is greater than a desired insulation stripping length,
effecting a stripping carriage movement corresponding to the desired insulation stripping length,
cutting completely through the cable, and
effecting a further stripping movement before opening at least one of said stripping knife and said knife actuating element.

37. An insulation stripping machine comprising:
at least one stripping knife,
a knife actuating element operatively connected to said at least one stripping knife,
a first drive for said knife actuating element,
a stripping carriage for effecting a relative stripping movement between said at least one stripping knife and a cable,
a second drive for said stripping carriage,
at least one knife sensor,
a programmable electronic control operatively connected to said sensor and to said drives, said programmable electronic control containing program instructions that, when executed cause said stripping knife and said stripping carriage to perform a method of stripping an insulated cable, the method comprising:
cutting into a cable insulation layer at a distance from a cable end that corresponds to a desired insulation stripping length,
effecting a stripping movement shorter than said desired insulation stripping length, and
performing an opposite stripping movement before opening at least one of said stripping knife and said knife actuating element.

38. An insulation stripping machine comprising:
at least one stripping knife,
a knife actuating element operatively connected to said at least one stripping knife,
a first drive for said knife actuating element,
a stripping carriage for effecting a relative stripping movement between said at least one stripping knife and a cable,
a second drive for said stripping carriage,
at least one knife sensor,
a programmable electronic control operatively connected to said sensor and to said drives, said programmable electronic control containing program instructions that, when executed cause said stripping knife and said stripping carriage to perform a method of stripping an insulated cable, the method comprising:
cutting into a cable insulation layer at a first distance from a cable end,
maintaining said stripping knife in an incision position for an adjustable time in order to ensure complete incision of said cable insulation layer before opening at least one of said stripping knife and said knife actuating element.

39. An insulation stripping machine comprising:
at least one stripping knife,
a knife actuating element operatively connected to said at least one stripping knife,
a first drive for said knife actuating element,
a stripping carriage for effecting a relative stripping movement between said at least one stripping knife and a cable,
a second drive for said stripping carriage,
at least one knife sensor,
a programmable electronic control operatively connected to said sensor and to said drives, said programmable electronic control containing program instructions that, when executed cause said stripping knife and said stripping carriage to perform a method of stripping an insulated cable, the method comprising:
cutting into a cable insulation layer at a first distance from a cable end,
maintaining said stripping knife in an incision position for an adjustable time in order to ensure complete incision of said cable insulation layer, and
cutting into a cable insulation layer to be stripped at a second distance from a cable end that is greater than a desired insulation stripping length.

40. An insulation stripping machine comprising:
at least one stripping knife,
a knife actuating element operatively connected to said at least one stripping knife,
a first drive for said knife actuating element,
a stripping carriage for effecting a relative stripping movement between said at least one stripping knife and a cable,
a second drive for said stripping carriage,
at least one knife sensor,
a programmable electronic control operatively connected to said sensor and to said drives, said programmable electronic control containing program instructions that, when executed cause said stripping knife and said stripping carriage to perform a method of stripping an insulated cable, the method comprising:
cutting into a cable insulation layer at a first distance from a cable end,
maintaining said stripping knife in an incision position for an adjustable time in order to ensure complete incision of said cable insulation layer,
effecting a stripping movement shorter than a desired insulation stripping length, and
performing an opposite stripping movement before opening at least one of said stripping knife and said knife actuating element.

41. An insulation stripping machine comprising:
at least one stripping knife,
a knife actuating element operatively connected to said at least one stripping knife,
a first drive for said knife actuating element,
a stripping carriage for effecting a relative stripping movement between said at least one stripping knife and a cable,
a second drive for said stripping carriage,
at least one knife sensor,
a programmable electronic control operatively connected to said sensor and to said drives, said programmable electronic control containing program instructions that, when executed cause said stripping knife and said stripping carriage to perform a method of stripping an insulated cable, the method comprising:
cutting into a cable insulation layer at a first distance from a cable end,
effecting a stripping movement that is longer than a desired insulation stripping length, and
effecting the action of cutting completely through a cable insulation layer to be stripped before opening said knife so as to prevent adhesion of stripped-off insulation pieces to said knife and to cut through any remaining residual connection between cable insulation layer and stripped-off insulation piece.

42. An insulation stripping machine comprising:
at least one stripping knife,
a knife actuating element operatively connected to said at least one stripping knife,
a first drive for said knife actuating element,
a stripping carriage for effecting a relative stripping movement between said at least one stripping knife and a cable,
a second drive for said stripping carriage,
at least one knife sensor,
a programmable electronic control operatively connected to said sensor and to said drives, said programmable electronic control containing program instructions that, when executed cause said stripping knife and said stripping carriage to perform a method of stripping an insulated cable, the method comprising:
cutting into a cable insulation layer at a first distance from a cable end that is shorter than a desired insulation stripping length,
effecting a stripping movement that is shorter than said first distance,
cutting completely through the cable,
opening said stripping knife,
positioning said stripping knife at a desired insulation stripping length,
cutting into a cable insulation layer to be stripped,
effecting a stripping movement shorter than said desired stripping length, and
opening at least one of said stripping knife and said knife actuating element.

43. An insulation stripping machine according to claim 42, wherein,
said method of stripping a cable further includes,
a step of effecting an opposite stripping movement prior to said step of opening at least one of said stripping knife and said knife actuating element.

44. An insulation stripping machine comprising:
at least one stripping knife,
a knife actuating element operatively connected to said at least one stripping knife,
a first drive for said knife actuating element,
a stripping carriage for effecting a relative stripping movement between said at least one stripping knife and a cable,
a second drive for said stripping carriage,
at least one knife sensor,
a programmable electronic control operatively connected to said sensor and to said drives, said programmable electronic control containing program instructions that, when executed cause said stripping knife and said stripping carriage to perform a method of stripping an insulated cable, the method comprising:
cutting into different layers of a coaxial cable with plural nonrotating cuts of different depths, and
stripping respective separated sections of the layers.

45. An insulation stripping machine according to claim 44, wherein,
said method of stripping a cable includes,
forming the plural nonrotating cuts at different distances from a cable end.

46. An insulation stripping machine according to claim 44, wherein,
said method of stripping a cable further includes,
effecting a stepwise stripping during said step of stripping respective separated sections of the layers.

47. An insulation stripping machine according to claim 44, wherein,
said method of stripping a cable further includes,
effecting a stripping together of separated sections during said step of stripping respective separated sections of the layers.

48. An insulation stripping machine comprising:
at least one stripping knife,
a knife actuating element operatively connected to said at least one stripping knife,
a first drive for said knife actuating element,
a stripping carriage for effecting a relative stripping movement between said at least one stripping knife and a cable,
a second drive for said stripping carriage,
at least one knife sensor,
a programmable electronic control operatively connected to said sensor and to said drives, said programmable electronic control containing program instructions that, when executed cause said stripping knife and said stripping carriage to perform a method of stripping an insulated cable, the method comprising:
cutting into a cable insulation layer to be stripped at a first distance from a cable end,
effecting a stripping movement that is shorter than the first distance,
cutting completely through the cable,
opening at least one of said stripping knife and said knife actuating element,
positioning said knife at a second distance from the cable end that corresponds to a desired insulation stripping length,
cutting the cable insulation layer to a desired depth, and
effecting a stripping movement that is shorter than the desired insulation stripping length.

49. An insulation stripping machine comprising:
at least one stripping knife,
a knife actuating element operatively connected to said at least one stripping knife,
a first drive for said knife actuating element,
a stripping carriage for effecting a relative stripping movement between said at least one stripping knife and a cable,
a second drive for said stripping carriage,
at least one knife sensor,
a programmable electronic control operatively connected to said sensor and to said drives, said programmable electronic control containing program instructions that, when executed cause said stripping knife and said stripping carriage to perform a method of stripping an insulated cable, the method comprising:
cutting into a cable insulation layer to be stripped at a first distance from a cable end,
effecting a stripping movement that is shorter than the first distance,
cutting completely through the cable,
opening at least one of said stripping knife and said knife actuating element,
positioning said knife at a second distance from the cable end that corresponds to a desired insulation stripping length,
cutting the cable insulation layer to a desired depth, and
effecting a stripping movement that corresponds to a desired cable end position.

50. An insulation stripping machine comprising:
at least one stripping knife,
a knife actuating element operatively connected to said at least one stripping knife,
a first drive for said knife actuating element,
a stripping carriage for effecting a relative stripping movement between said at least one stripping knife and a cable,
a second drive for said stripping carriage,
at least one knife sensor,
a programmable electronic control operatively connected to said sensor and to said drives, said programmable electronic control containing program instructions that, when executed cause said stripping knife and said stripping carriage to perform a method of stripping an insulated cable, the method comprising:
cutting into a cable insulation layer to be stripped at a first distance from a cable end,
effecting a stripping movement that corresponds to a desired cable end position,
cutting completely through the cable,
opening at least one of said stripping knife and said knife actuating element,
positioning said knife at a second distance from the cable end that corresponds to a desired insulation stripping length,
cutting the cable insulation layer to a desired depth, and
effecting a stripping movement that is shorter than the desired insulation stripping length.

51. An insulation stripping machine comprising:
at least one stripping knife,
a knife actuating element operatively connected to said at least one stripping knife,
a first drive for said knife actuating element,
a stripping carriage for effecting a relative stripping movement between said at least one stripping knife and a cable,
a second drive for said stripping carriage,
at least one knife sensor,
a programmable electronic control operatively connected to said sensor and to said drives, said programmable electronic control containing program instructions that, when executed cause said stripping knife and said stripping carriage to perform a method of stripping an insulated cable, the method comprising:
cutting into a cable insulation layer to be stripped at a first distance from a cable end,
effecting a stripping movement that corresponds to a desired cable end position,
cutting completely through the cable,
opening at least one of said stripping knife and said knife actuating element, positioning said knife at a second distance from the cable end that corresponds to a desired insulation stripping length,
cutting the cable insulation layer to a desired depth, and
effecting a stripping movement that corresponds to a desired cable end position.
